(19) United States
(12) Patent Application Publication
(10) Pub. No.: US 2021/0104336 A1
(43) Pub. Date: Apr. 8, 2021

(54) Changing Density Particles Having a Neutron Absorbent and a Thermal Conductor

(71) Applicant: A. Robert Abboud and Company, Fox River Grove, IL (US)

(72) Inventor: Robert G. Abboud, Barrington Hills, IL (US)

(21) Appl. No.: 16/499,456

(22) PCT Filed: Mar. 27, 2018
(86) PCT No.: PCT/US18/24682

§ 371 Date: Sep. 30, 2019

Related U.S. Application Data
(60) Provisional application No. 62/478,024, filed on Mar. 28, 2017.

(51) Int. Cl. G21F 9/30; G21F 1/06; G21F 1/10; G21F 5/008; G21F 5/14

(52) U.S. Cl. CPC G21F 9/305; G21F 1/06; G21F 9/301; G21F 5/008; G21F 5/14; G21F 1/10

(57) ABSTRACT

Composition, manufactures, and methods of making and using them, illustratively a process including the steps of: changing density of a composition including a neutron absorbent, the absorbent having a neutron absorption cross section greater than or equal to Boron comprising at least 19.7% of Boron-10 isotope, and a thermal conductor having a thermal conductivity of at least 10% of coolant thermal conductivity at 100 degrees C. at sea level, combined into the particles that have a density of at least 0.9982 g/mL and not more than 2.0 g/ml, the altering carried out in association with nuclear fuel or nuclear waste in a cask that is not located in a nuclear reactor containment vessel, the cask being a nuclear fuel cask or a spent nuclear fuel cask, the changing carried out by relocating the composition by at least one of the sub steps comprising: (A) operating a hollow conduit connected to a reservoir to relocate at least some of the particles from a reservoir into the cask, and/or (B) altering a close pack formation of the particles by effectuating a change from a static coefficient of friction of the particles to a dynamic coefficient of friction of the particles, thereby redistributing the particles within the cask into an altered close pack formation, and/or (C) removing at least some of the particles from the cask into the reservoir.

### CROSS REFERENCE

This application claims the benefit of U.S. Provisional Patent Application No. 62/478,024, filed on Mar. 28, 2017, and benefit and priority of Patent Application No. PCT/US18/24612, both of which are incorporated by reference in the entirety.

### BACKGROUND

Nuclear safety poses, of course, important technological problems. Storage of a nuclear material, such as nuclear fuel, spent nuclear fuel, and nuclear waste, can be understood in light of the following Engineering Calculation Note #13-006-001.0.0—Section 2. (ref: Hoi Hg, Stanford University, Mar. 19, 2014):
“Spent fuel is the nuclear fuel is nuclear fuel that has been “burned” in a nuclear reactor. It is often highly radioactive, and it generates huge amount of decay heat as a result of beta decay of fissile products, although the fissile chain reaction has ceased. Quantitatively, spent fuel, five minutes after reactor shutdown, can still release about 800 kilowatts of heat per metric ton of uranium. Even though the production rate of decay heat will continue to slow down over time (for instance, decay heat will fall to 0.4% of the original core power level after a day), spent fuel has to cool down and store securely before being sent for reprocessing or long term disposal.
For dry cask storage, spent fuel that has cooled in spent fuel pool for at least one year can be encapsulated in a steel dry cask, which is welded or bolted closed when it is moved out from water. The cask is pumped with inert gas inside, and then is contained into another cask made of steel, concrete, or other radiation shielding material. Subsequently, this leak-tight and radiation-shielded dry cask can be stored either horizontally in concrete over-pack or vertically on a concrete pad. One design for casks oriented vertically is called the thick-walled cask, whereas cask with over-pack is normally the design for horizontal storage. The former makes use of the very thick exterior wall as the protection to radiation for each cask, while the latter uses thin outer wall for each cask and relies on the concrete bunker to provide radiation protection. Thanks to its standalone protection, thick-walled cask erected vertically is more prevalent nowadays. A schematic structure of dry cask is given in FIG. 1 and in both orientations, FIG. 2a, and FIG. 2b.
   Regardless of the cask type, the cooling mechanism of dry casks follows these heat-transfer events.
   Heat release in fuel matrix due to radioactive decay.
   Heat conduction in the fuel and through the cladding.
   Convection heat transfer from fuel rods due to natural convection of gaseous coolant inside vertically or horizontally oriented casks.
   Thermal radiation inside casks, radiation heat transfer between the rows of fuel rods and between the fuel and basket-surrounding elements.
   Heat conduction through internal elements of the cask and through its thick body wall.
   Natural convection and thermal radiation from the casks outer surface to the environment
The dry cask storage is less prone to catastrophes. Different from spent fuel pool, dry casks exploit passive cooling by natural convection that is driven by the decay heat of the spent fuel itself. In other words, dry cask is not vulnerable to loss of coolant, which, in comparison, will result in cascade of accidents in spent fuel pool. Moreover, given the fact that nuclear power plants are usually surrounded by ample exclusion area, one can spread out the casks when each of them contains only small amount of radioactive substances. That means, to cause a huge amount of airborne release or wide spread fire, a big number of casks must fail or be attacked simultaneously, not to mention that each cask has its strong protection wall. Other advantages of dry casks include no moving parts, no electricity, relatively simple maintenance (check of vent blockage), and dual-purposes of storage and transportation vehicle.

Two main reasons hindering in moving older spent fuel from pools to dry casks are the high cost and the low availability of casks. It costs about 1 million USD for each cask and another half million USD to load each one with fuel. The concrete pad for casks to sit on (See FIG. 1) costs another 1 million USD. A rough estimated cost to move all of the fuel in the United States that has cooled in pools for at least five years could cost 7 billion USD. In addition to high cost, the low production rate of the cask is another limiting factor. There are other issues of dry casks such as additional chance of human errors and radiation risks. The extra step of moving spent fuels from pools to casks, compared to sitting in the pools until long term disposal, poses higher odds to accidents caused by human mishandling; furthermore, it imposes additional radiation doses to workers who transfer the spent fuels from the water. Additionally, the lifetime of dry casks is an issue as they are vulnerable to environmental conditions.”

Storage can be subject to public outcry, as indicated by a posting on Aug. 21, 2014 by Donna Gilmore, Premature failure of U.S. spent nuclear fuel storage canisters, wherein it is reported that
“The California Public Utilities Commission (CPUC) should delay funding the new San Onofre dry cask storage system until Southern California Edison provides written substantiation that the major problems identified below are resolved . . . The dry cask systems Edison is considering may fail within 30 years or possibly sooner, based on information provided by Nuclear Regulatory Commission (NRC) technical staff. There is no technology to adequately inspect canisters. There is no system in place to mitigate a failed canister. Edison should consider other dry casks systems that do not have these problems.”

In Nuclear Monitor Issue #454, (Jun. 21, 1996) Loading of spent nuclear fuel into dry storage containers was suspended at the nuclear plant in Point Beach (Wisconsin, US) following an explosion during a welding procedure 28 May, reports:
(454.4491) WISE Amsterdam—According to an initial report of the Nuclear Regulatory Commission (NRC), initial report, an unidentified gas ignited inside a fully-loaded cask of nuclear waste containing 14 tons of spent fuel rods at 2:45 a.m. of the said date, causing an explosion. The explosion occurred just prior to the welding of the 9-inch thick cask lid that weighs about 4,400 pounds. The explosion inside the cask lifted the 2-ton lid, leaving it tipped at an angle with one edge 1 inch higher than normal. There were no injuries.
   The NRC has suspended further loading of nuclear waste casks until it can determine the cause of the accident and whether any spent fuel rods were damaged by the explosion. Each 18-foot high cask is loaded with 14 tons of radioactive waste, including 170 pounds of plutonium. Each loaded silo contains the equivalent radioactivity of 240 Hiroshima-type explosions. According to US guidelines, the waste must be kept in safe conditions for 10,000 years.
   The explosion confirms environmental groups' concerns that the VSC-24 dry cask storage system has not been sufficiently reviewed to protect public health and the environment. This radioactive waste storage explosion demonstrates the real threat to the Great Lakes ecosystem.

### SUMMARY

Responsive to need for better nuclear safety, including storage of nuclear material, such as nuclear fuel, spent nuclear fuel, and nuclear waste, a composition is added to a storage structure's environment. Often the storage structure will be a cask, such as a nuclear fuel cask or spent nuclear fuel cask. The composition, or additive, can include particles comprising a non-gaseous neutron absorbent having a neutron absorption cross section greater than Boron comprising at least 19.7% of Boron-10 isotope and a thermal conductor having a thermal conductivity of at least 10% of water thermal conductivity at 100 degrees C. at sea level, combined to have a density of at least 0.9982 g/mL and not more than 2.0 g/ml. The particles can, but need not, be glass, ceramic, an aggregate, or some combination of them. The particles can, but need not always, be a composite. The technical effects of the compositions disclosed herein can include stabilizing the nuclear material while absorbing neutronic radiation and conveying heat away from the nuclear material, and the processes of using the composition, such as in loading, storing, and unloading, concomitantly advance over conventional processes. It is believed that such compositions concomitant processes represent an advance in comparison with conventional coolants, such as water, and processes of using the concomitant processes represent an advance in comparison with conventional processes. Processes can include altering the density the composition as carried out in association with nuclear fuel or nuclear waste in a cask that is not located in a nuclear reactor containment vessel.

Depending on the implementation, there is apparatus, manufactures, composition of matter, and processes for using and processes for making the foregoing, as well as products produced thereby and necessary intermediates of the foregoing.

### INDUSTRIAL APPLICABILITY

Depending on the implementation, industrial applicability is illustratively directed to nuclear science, nuclear engineering, material science, and mechanical engineering. These may be related to storage of nuclear material such as nuclear fuel, spent nuclear fuel, nuclear waste, as well as industries operating in cooperation therewith.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### DRAWINGS

FIG. 1 is an indication of a dry cask that is prior art.

FIG. 2A is a schematic indication of a dry cask in a vertical orientation as prior art.

FIG. 2B is a schematic indication of a dry cask in a horizontal orientation as prior art.

FIG. 3 is a schematic indication of one possible configurations of a particle involving a core.

FIG. 4 is an illustration of another possible configuration of a particle involving a foam.

FIG. 5 is an illustration of another possible configuration of a particle involving an aggregate.

FIG. 6 is an illustration of close pack orientation.

FIG. 7 is a schematic indication illustration of a cask containing particles and nuclear material.

FIG. 8 is a process flow chart indicating loading.

FIG. 9 is a process flow chart that continues the process flow of FIG. 9.

FIG. 10 is a process flow chart indicating transport and storage.

FIG. 11 is a process flow chart indicating unloading.

FIG. 12 is a process flow chart that continues the process flow of FIG. 11.

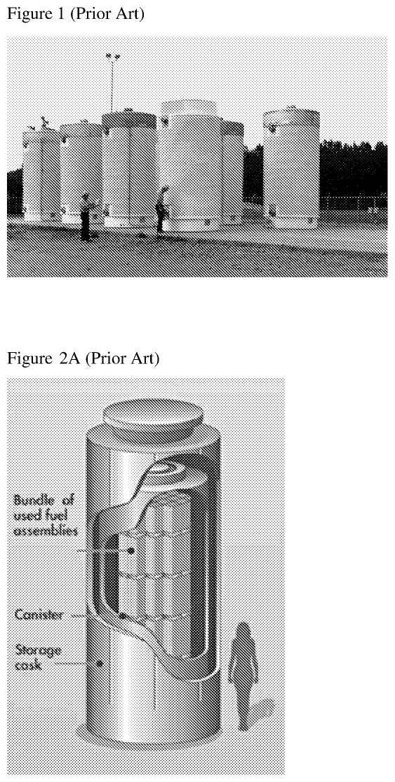

As mentioned above a composition is employed as an additive to a nuclear environment, such as an additive into the space between a nuclear material and a cask, e.g., nuclear fuel cask, spent nuclear fuel cask, etc. The additive can be particles made of a composite material including a neutron absorbent, the absorbent having a neutron absorption cross section greater than or equal to Boron comprising at least 19.7% of Boron-10 isotope, and a thermal conductor having a thermal conductivity of at least 10% of water thermal conductivity at 100 degrees C. at sea level, combined such that the particles have a density of at least 0.9982 g/mL and not more than 2.0 g/ml. While the neutron absorption cross section can be provided by Boron comprising at least 19.7% of Boron-10 isotope, this need not always be the case as the neutron absorption cross section can be provided by any material with a thermal neutron capture cross-section of greater than 0.300 barns. Examples of these materials are listed in Table 1 below:

TABLE 1

| Element Name | Isotope |
|---|---|
| Boron | B-10 |
| Hydrogen | H-1 |
| Neon | Ne-21 |
| Sodium | Na-23 |
| Sulphur | S-32 |
| Chlorine | Cl-35; Cl-36; Cl-37 |
| Argonne | Ar-36; Ar-39; Ar-40; Ar-41 |
| Potassium | K-39; K-40; K-41 |
| Calcium | Ca-40; Ca-41; Ca-42; Ca-43; Ca-44; |
| | Ca-45; Ca-46; Ca-48 |
| Scandium | Sc-45; SC-46 |

Thermal conductors having a thermal conductivity of at least 10% of water thermal conductivity at 100 degrees C. at sea level include:

TABLE 2

| | | | | |
|---|---|---|---|---|
| Phosphorus | 0.00235 | W/cmK | P | 15 |
| Sulfur | 0.00269 | W/cmK | S | 16 |
| Iodine | 0.00449 | W/cmK | I | 53 |
| Astatine | 0.017 | W/cmK | At | 85 |
| Selenium | 0.0204 | W/cmK | Se | 34 |
| Tellurium | 0.0235 | W/cmK | Te | 52 |
| Neptunium | 0.063 | W/cmK | Np | 93 |
| Plutonium | 0.0674 | W/cmK | Pu | 94 |
| Manganese | 0.0782 | W/cmK | Mn | 25 |
| Bismuth | 0.0787 | W/cmK | Bi | 83 |
| Mercury | 0.0834 | W/cmK | Hg | 80 |
| Americium | 0.1 | W/cmK | Am | 95 |
| Californium | 0.1 | W/cmK | Cf | 98 |
| Nobelium | 0.1 | W/cmK | No | 102 |
| Curium | 0.1 | W/cmK | Cm | 96 |
| Lawrencium | 0.1 | W/cmK | Lr | 103 |
| Fermium | 0.1 | W/cmK | Fm | 100 |
| Einsteinium | 0.1 | W/cmK | Es | 99 |
| Berkelium | 0.1 | W/cmK | Bk | 97 |
| Mendelevium | 0.1 | W/cmK | Md | 101 |
| Gadolinium | 0.106 | W/cmK | Gd | 64 |
| Dysprosium | 0.107 | W/cmK | Dy | 66 |
| Terbium | 0.111 | W/cmK | Tb | 65 |
| Cerium | 0.114 | W/cmK | Ce | 58 |
| Actinium | 0.12 | W/cmK | Ac | 89 |
| Praseodymium | 0.125 | W/cmK | Pr | 59 |
| Samarium | 0.133 | W/cmK | Sm | 62 |
| Lanthanum | 0.135 | W/cmK | La | 57 |
| Europium | 0.139 | W/cmK | Eu | 63 |
| Erbium | 0.143 | W/cmK | Er | 68 |
| Francium | 0.15 | W/cmK | Fr | 87 |
| Scandium | 0.158 | W/cmK | Sc | 21 |
| Holmium | 0.162 | W/cmK | Ho | 67 |
| Lutetium | 0.164 | W/cmK | Lu | 71 |
| Neodymium | 0.165 | W/cmK | Nd | 60 |
| Thulium | 0.168 | W/cmK | Tm | 69 |
| Yttrium | 0.172 | W/cmK | Y | 39 |
| Promethium | 0.179 | W/cmK | Pm | 61 |
| Barium | 0.184 | W/cmK | Ba | 56 |
| Radium | 0.186 | W/cmK | Ra | 88 |
| Polonium | 0.2 | W/cmK | Po | 84 |
| Titanium | 0.219 | W/cmK | Ti | 22 |
| Zirconium | 0.227 | W/cmK | Zr | 40 |
| Hafnium | 0.23 | W/cmK | Hf | 72 |
| Rutherfordium | 0.23 | W/cmK | Rf | 104 |
| Antimony | 0.243 | W/cmK | Sb | 51 |
| Boron | 0.274 | W/cmK | B | 5 |
| Uranium | 0.276 | W/cmK | U | 92 |
| Vanadium | 0.307 | W/cmK | V | 23 |
| Ytterbium | 0.349 | W/cmK | Yb | 70 |
| Strontium | 0.353 | W/cmK | Sr | 38 |
| Lead | 0.353 | W/cmK | Pb | 82 |
| Cesium | 0.359 | W/cmK | Cs | 55 |
| Gallium | 0.406 | W/cmK | Ga | 31 |
| Thallium | 0.461 | W/cmK | Tl | 81 |
| Protactinium | 0.47 | W/cmK | Pa | 91 |
| Rhenium | 0.479 | W/cmK | Re | 75 |
| Arsenic | 0.502 | W/cmK | As | 33 |
| Technetium | 0.506 | W/cmK | Tc | 43 |
| Niobium | 0.537 | W/cmK | Nb | 41 |
| Thorium | 0.54 | W/cmK | Th | 90 |
| Tantalum | 0.575 | W/cmK | Ta | 73 |
| Dubnium | 0.58 | W/cmK | Db | 105 |
| Rubidium | 0.582 | W/cmK | Rb | 37 |
| Germanium | 0.599 | W/cmK | Ge | 32 |
| Tin | 0.666 | W/cmK | Sn | 50 |
| Platinum | 0.716 | W/cmK | Pt | 78 |
| Palladium | 0.718 | W/cmK | Pd | 46 |
| Iron | 0.802 | W/cmK | Fe | 26 |
| Indium | 0.816 | W/cmK | In | 49 |
| Lithium | 0.847 | W/cmK | Li | 3 |
| Osmium | 0.876 | W/cmK | Os | 76 |
| Nickel | 0.907 | W/cmK | Ni | 28 |
| Chromium | 0.937 | W/cmK | Cr | 24 |
| Cadmium | 0.968 | W/cmK | Cd | 48 |
| Cobalt | 1 | W/cmK | Co | 27 |
| Potassium | 1.024 | W/cmK | K | 19 |
| Zinc | 1.16 | W/cmK | Zn | 30 |
| Ruthenium | 1.17 | W/cmK | Ru | 44 |
| Carbon | 1.29 | W/cmK | C | 6 |
| Molybdenum | 1.38 | W/cmK | Mo | 42 |
| Sodium | 1.41 | W/cmK | Na | 11 |
| Iridium | 1.47 | W/cmK | Ir | 77 |
| Silicon | 1.48 | W/cmK | Si | 14 |
| Rhodium | 1.5 | W/cmK | Rh | 45 |
| Magnesium | 1.56 | W/cmK | Mg | 12 |
| Tungsten | 1.74 | W/cmK | W | 74 |
| Calcium | 2.01 | W/cmK | Ca | 20 |
| Beryllium | 2.01 | W/cmK | Be | 4 |
| Aluminum | 2.37 | W/cmK | Al | 13 |
| Gold | 3.17 | W/cmK | Au | 79 |
| Copper | 4.01 | W/cmK | Cu | 29 |
| Silver | 4.29 | W/cmK | Ag | 47 |

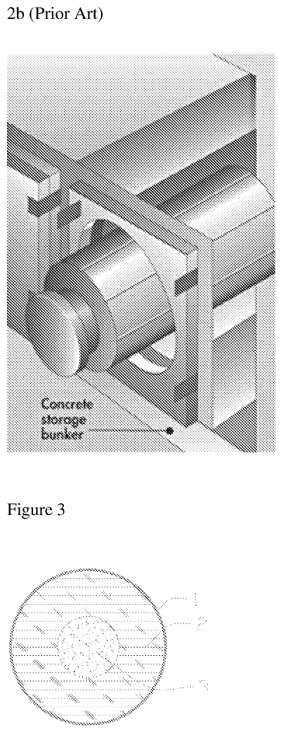

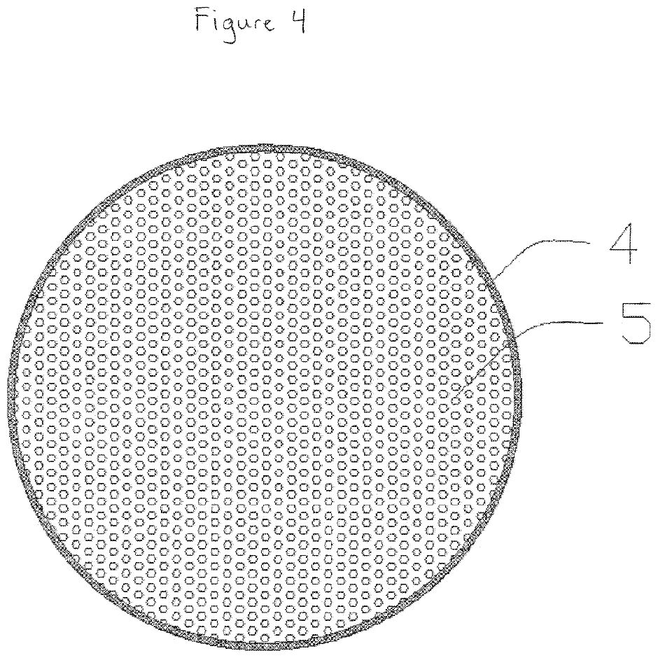

While any combination of the foregoing may be employed to produce particles of the neutron absorbent having the neutron absorption cross section greater than or equal to Boron comprising at least 19.7% of Boron-10 isotope, and the thermal conductor having a thermal conductivity of at least 10% of water thermal conductivity at 100 degrees C. at sea level, it is noted that some of the foregoing are exceptionally hazardous materials, which weigh against their preferred use. An additional constraint is that the particles have a density of at least 0.9982 g/mL and not more than 2.0 g/ml. Some embodiments have the particles being a composite, and one—but not the only—arrangement is illustrated in FIG. 3.

FIG. 3 provides an indication of an exterior layer 1, intermediate layer 2, and core 3 For example, the particles can include a metal as the exterior layer 1, a glass intermediate layer 2, and inert gas as the core. This and other configurations are discussed below.

### EXAMPLE 1

### Glass

There can be one or more glasses, one or more metals, and/or one or more inert gasses. The glass can be borosilicate glass—a type of glass with the main glass-forming constituents silica and boron oxide. Borosilicate glasses are known for having very low coefficients of thermal expansion (˜3×10-6/° C. at 20° C.), making them resistant to thermal shock, more so than any other common glass. Such glass is less subject to thermal stress and is commonly used for the construction of reagent bottles. Glasses, such as borosilicate glass, commercially referred to as Pyrex™ glass, and borosilicate glasses are sold under such trade names as Simax™, Suprax™, Kimax™, Pyrex™, Endural™, Schott™, or Refmex™. Such glasses already have an amount of boron as part of their chemical makeup, making them notably suitable for some embodiments. More generally, glass formulations can be adjusted so the interactions of the above-mentioned ranges combine to define the glass formulations and configurations as may be desired in the particular embodiment of interest. Some embodiments can use as a glass formulation the glass recycled from old TV's and monitors (CRT glass) because of the additives in this glass were formulated to minimize irradiation exposure to humans by x-rays from the cathode ray components. This glass is suitable, in some embodiments, for use as the glass component after being melted down and reformed.

Illustratively with respect to FIG. 3, the particles can include a filling or primarily including an inert gas 3, such as Helium, as the core 3. The core 3 can be defined as at least one bubble in borosilicate glass 3 enriched with Boron-10 isotope, which in turn is within metal coating 1. The internal gas for the additive composite bead may be a single bubble located at the center of the glass matrix, or as a gas dispersed throughout the glass matrix in a plethora of smaller bubbles the sum comprising the same volume as the single bubble configuration, as discussed below.

### EXAMPLE 2

### Bubble

Illustratively, the glass of the composite can be a borosilicate glass formed into beads and layered. In some embodiments, the beads can have at least one bubble filled or primarily filled with at least one inert gas such as Helium. The beads can have a layer of a metal, such as an outer layer of a metal illustratively coating with as metal layer typically produced by vapor deposition or other commercially available coating process. The metal can be one of the metals listed above, such as Chromium and/or Molybdenum. The borosilicate glass can be located between the at least one bubble and the outer layer. While the composite can have whatever configuration is desired for the particular requirements of an embodiment having the neutron absorbent and thermal conductor as may be desired for a particular application, illustratively for teaching purposes, consider the following sub examples below.

### EXAMPLE 2A

### At Least One Bubble

A bubble in the glass can be made in many ways, one of which includes essentially blowing molten glass bubbles, sealing the bubbles, and then cooling the bubbles. The bubbles can be blown with, or primarily with, an inert gas such as Helium. One approach includes ejecting from a die a cylinder of molten glass, such as borosilicate glass. As the cylinder is being ejected, the inert gas is injected into the molten cylinder, e.g., via a port in the die, thereby forming a tube containing the inert gas. Sheering an end of the tube, ejecting more of the molten glass tube with the inert gas therein, and then sheering another end seals an internal bubble containing or primarily containing the inert gas between the wall of the tube and the sheered ends, thereby forming a bubble. Cooling the bubble can be carried out in part by gravity tumbling the bubble along a ramp to help round edges of the bubble as the bubble solidifies into a glass bubble containing or primarily containing the inert gas. Additional cooling can be carried out as usual for cooling glass. For a bubble containing more than one such bubble, multiple ports can be used to eject the inert gas into the molten glass as it is ejected.

Alternatively, a molten tube of glass can be ejected from a die into an inert gas environment. As above, sheering an end of the tube, ejecting more of the molten glass tube within the inert gas environment, and then sheering another end seals an internal bubble containing or primarily containing the inert gas between the wall of the tube and the sheered ends, thereby forming a bubble. Again, cooling the bubble can be carried out in part by gravity tumbling the bubble along a ramp to help round edges of the bubble as the bubble solidifies into a glass bubble containing or primarily containing the inert gas; additional cooling can be carried out as usual for cooling glass, resulting in glass beads containing at least one glass bubble.

In sum, illustratively then, composite particles (beads) can be fabricated using a number of processes, including forming at least one bubble within a layer of borosilicate glass (ceramic, and/or aggregate as discussed below). Note that FIG. 3 is not the only configuration possible as the glass bead can be doped and/or coated with a suitable neutron absorber as listed above, and indeed some configurations need not have a core, such as where a bead is formed from a froth of inert gas, as discussed below.

### EXAMPLE 2B

### Foam

As illustrated in FIG. 4, the inert gas or gasses of interest can be injected into a batch of molten glass, such as the above-mentioned borosilicate glass to produce a froth. The froth is ejected from a die to produce cylindrical ejection that is sheered to produce glass beads containing the froth that in turn contains or primarily contains the inert gas. The beads are rounded, cooled, and coated and/or doped as above.

### EXAMPLE 3

### Aggregate

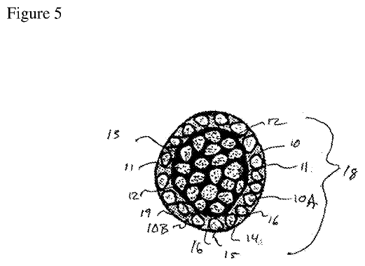

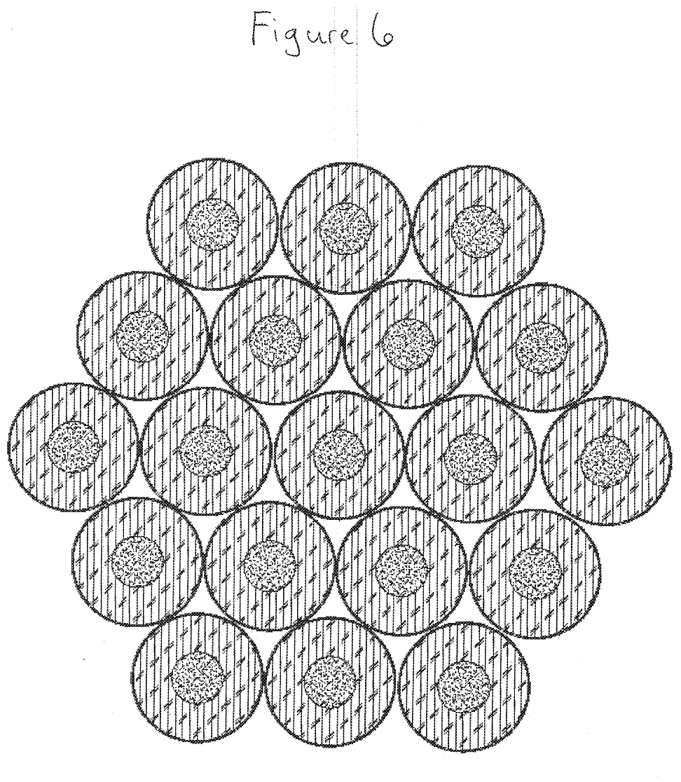

As illustrated in FIG. 5, particles can be formed as aggregate beads, for example, by using techniques disclosed in U.S. Pat. No. 5,628,945, incorporated by reference in its totality. The process includes mixing particles of a first powder 10 and a triggerable granule facilitator 11 to form first microcapsules 12, each having a core comprising one or more of the particles 10 and a coating of the facilitator 11; triggering the facilitator 11 to form granules 13 (one shown in FIG. 5) of the microcapsules 12. Mixing particles of a second powder 10A with the facilitator 11 (or another facilitator) to form second microcapsules 16, each having a core 15 of at least one of the particles of the second powder 10A and a coating of the facilitator 11 (or another facilitator); and mixing the first and the second microcapsules 12 and 16 prior to a triggering step, or retriggering the facilitator 11, to form a combination 18 of the microcapsules 12 and 16. As illustrated in FIG. 4, there can be another facilitator 19 that may or may not contain other particles 10B, depending on the embodiment of interest. The combination 18 is heated sufficiently to remove at least a portion of the facilitator(s) 11 and form an aggregate. The facilitator 11 can, but need not always, be one or more metalorganic soap; similarly, the first powder and the second powder can be particles of a ceramic, metal, organic, plastic, polymer, the glass, and/or the glass beads bubbled or foamed, described above, etc. The process can include third or more microcapsules to produce a distribution of the neutron absorbent(s) and thermal conductor(s) as may be desired.

### EXAMPLE 3

### Ceramic

In another example, the particles are layered as in FIG. 3 or foamed as in FIG. 4, with at least one bubble of helium, an outer layer as discussed above, e.g., chromium and/or molybdenum. A ceramic containing the neutron absorbent is located between said at least one bubble and the outer layer, and as above, the aggregate particle may or may not be doped, depending on the embodiment of interest.

For example, in FIG. 3—that area which is intermediate the internal bubble(s) and the outer metal layer, can be comprised of a ceramic. Ceramic materials are suitable because of their structural toughness, good thermal conductor, reliable physical properties, and the ability to contain a suitable neutron absorber such as boron. Several different forms of ceramics are suitable where ceramic materials ranges from highly oriented to semi-crystalline, vitrified, or completely amorphous (e.g., glasses), and illustratively suitable are non-crystal and ceramics. But noncrystalline ceramics, being glass, tend to be formed from melts. The glass is shaped when either fully molten, by casting, drop casting, or when in a state of toffee-like viscosity, by methods such as blowing into a mold. If later heat treatments cause this glass to become partly crystalline, the resulting material is known as a glass-ceramic, widely used as cook-top and also as a glass composite material for nuclear waste disposal (e.g. vilification). Specific examples for ceramics include boron oxide and boron nitride. In these two cases, the B-10 isotope making up 19.7% or more of the boron inventory provides a powerful neutron absorber.

### EXAMPLE 4

### Plastic or Polymer

In another example, the particles are formed employing a plastic or polymer such as polyetheretherketone or polyetherimid. A neutron absorbent can be incorporated into the plastic or polymer either as an aggregate or as an isotope of the base chemistry of the plastic or polymer. The plastic or polymer may be used to coat an internal bubble or bubbles or foam. However, a polymeric configuration can be carried out without such bubble(s) or foam, e.g., where the particle is of low enough density and meets the structural requirements as described above. However, in some cases, the plastic or polymer may then be coated with a hard and low friction coating, such as chromium or molybdenum as described herein. Alternatively, the plastic or polymer may have a sufficient hardness, friction coefficient, and thermal conductivity suitable for the application negating the need for an additional coating.

### EXAMPLE 5

### Mixture

In yet another example, the particles include a mixture of the foregoing. That is, to configure a totality of particles for the embodiment of interest, the particles can be a mixture of two or more of the above-mentioned configurations.

### Other Characteristics of Interest

Depending on the embodiment of interest, including but not limited to any one of the foregoing, the particles, when packed in maximum packing configuration of face center cubic array or hexagonal closest packing, as illustrated in FIG. 6, so as to have a gross density less than or equal to the density of water. Note that in some cases, particles of a greater gross density can be used within the limits of the structural requirements of the cask and its margin of safety, but such is not typically of choice. Typically, the particles can be individually somewhat heavier than water or the coolant of interest. This density will allow the particles to be poured under water (coolant) into a cask containing the nuclear material and displace some of the water (coolant). When the cask is sealed and then vented to remove remaining water, the beads are in a close pack formation to support the fuel or material, as illustrated in FIG. 6. In this close pack formation, the particles preferably are collectively lighter than the water (coolant), so as not to add more than the water (coolant) weight to the cask.

Generally, the particles can be hard (e.g., Chromium), providing for low friction and low deformability, with a hardness rating of typically greater than 65 on the Rockwell C scale. However, for certain applications, a softer particle, coating, or exterior, such as lead, may be desirable. Generally though, the particles can, but need not always, have sufficient structural integrity, size, and friction that, when packed in random maximum density packing, collectively resist deflection and/or displacement of forces between 10 g's and 40 g's, and indeed, where desired, at least some of the particles deformably cushion against the mechanical shocks—sometimes at least some of the particles are deformable sufficient to cushion against the mechanical shocks beyond 10 g's, in some cases, beyond 100 g's, and in yet other cases, up to and including 60,000 g's depending upon the time duration of the shock loading.

Typically, the particles include particles that are spherical shaped, and/or spheroid shaped, and/or ellipsoid shaped and have a dimension in the range of 0.1 mm to 20 mm. In many cases the particles are not completely or even substantially metal.

If so desired, the particles can have a static coefficient of friction between 0.02 and 0.75, and in some cases, the additive particles behave as a non-Newtonian fluid.

Embodiments can be carried out so that the particles are configured to provide any combination of:

1. a structural support;

2. a thermal conductivity to reduce fuel rod temperature sufficiently to allowing cask re-flooding and reopening the cask for inspection and management (e.g., below 150 C degrees, and in other cases below 150 degrees C.);

3. provide a nuclear fission shut-down margin.

The selection of, and amounts of, or ranges for, structural support, thermal conductivity, nuclear fission shut-down margin, and integrity can be selected the particular implementations as may be desired.

Additionally, the particles can, if so desired, be configured to withstand high radiation levels for a long time (e.g., 100 years and better sti11,1000 years, with a total absorbed dose in the range of 10 Teragray (Tgy)) and

The selection of, and amounts of, or ranges for, hardness and strength, and the duration for withstanding the radiation can be tailored to the particular implementations as may be desired.

Generally, the particles should not be so heavy as to make the casks non-transportable or over tax their mechanical design rating. The particles can be small enough to flow into the spaces around the fuel or nuclear material and provide support for the fuel or nuclear material, but not so small and/or shaped that they make the cask too heavy or make it impractical to remove the particles for inspecting the contents of the cask. The particles therefore should be reasonably round—round enough to permit flowing into the spaces adjacent to the fuel or nuclear material in the cask.

Illustratively, as a teaching example, consider the beads being spherically or ellipsoidally shaped, having an outer diameter of 0.090″ (2.286 mm). The particles can be enriched in Boron-10 isotope for good thermal neutron absorption and thermal shock resistance. Each of the beads of this diameter can be configured as one or more bubbles so that the particle density is about 110% the density of water—just slightly heavier than water individually, but in a close pack formation, lighter than water as a group given equivalent volume. The bubble can be filled or primarily filled with one or more inert gasses, e.g. such as Helium. The particles can have a coating of perhaps 200 microns of a metal such as Chromium, Molybdenum, or a combination thereof, which facilitates thermal conductivity without presenting a significant thermal expansion problem. Illustratively, the beads can, but need not, be as follows.

Outer diameter: 2.286 mm

Glass bubble: 0.04909 mm

Glass thickness: 0.89391 mm

Coating, i.e., Chrome thickness: 0.2 mm

The foregoing is merely illustrative and would be adjusted as may be desired in one implementation or another, for example, to optimize neutronic, thermal, structural, and cost performance. Indeed, in another embodiment, consider a 30-micron coating in the Table 3 as follows:

TABLE 3

| | | | |
|---|---|---|---|
| Density of water | 0.001 | g/mm\hat{ }3 | |
| Density of borosilicate glass | 0.0023 | g/mm\hat{ }3 | |
| Density of He | 1.78E−07 | g/mm\hat{ }3 | |
| Density of Chrome plate | 0.0072 | g/mm\hat{ }3 | |
| Bead radius (r4) | 1.143 | Mm | |
| Bead diameter | 2.286 | Mm | |
| Chrome thickness | 0.03 | Mm | |
| Mass of water drop | 0.014386 | G | |
| Target mass at +10% | 0.015825 | G | |
| HE radius | 0.45 | Mm | |
| He diameter | 0.9 | Mm | |
| He mass | 6.79E−08 | G | |
| Glass inner/outer radius | 0.45 | 1.113 | Mm |
| Glass outer diameter | 2.226 | Mm | |
| Glass mass | 0.012405 | G | |
| Glass thickness | 0.663 | Mm | |
| Chrome inner/outer radius | 1.113 | 1.143 | |
| Chrome outer diameter | 2.286 | Mm | |
| Chrome mass | 0.003454 | G | |
| Bead total mass | 0.015859 | G | |

More generally, though, the additive can include any of the non-gaseous neutron absorbents having a neutron absorption cross section greater than Boron comprising 19.7% of Boron-10 in a combination with and a thermal conductor such that the combination has a thermal conductivity of at least 10% of water thermal conductivity, the combination providing a cushion against mechanical shocks. The additive can be any of mechanically, chemically, and atomically stable at 100 degrees C., e.g., for more than 100 years. The additive can comprise a glass, metal, ceramic, polymer, or aggregate particles, and in some embodiments, additive behaves as a non-Newtonian fluid which provides some of the cushion against the mechanical shocks. In some but not all cases, the glass is borosilicate glass configured to have an internal gas bubble, or bubbles, that contain or primarily contain an inert gas such as Helium. The additive can comprise a glass, metal, ceramic, polymer, or aggregate particles, and in some embodiments, a portion of the additive partially or completely deforms which provides some of the cushion against the mechanical shocks. In a bubble configuration, the glass beads can, but need not, have an outer diameter in the range of 0.05 mm to 20 0 mm, a wall thickness between the bubble and an outer diameter of the bubbles is in the range of 0.100 mm to 2.75 mm, and/or be spherically shaped and have a static coefficient of friction between 0.02 and 0.75. In some but not all cases, the glass beads can have sufficient structural integrity, size, and friction that, when packed in random maximum density packing, collectively resist deflection and/or displacement of a force of 20 gs.

In some embodiments, the glass beads can each have a density greater than or equal to the density of water, and if so desired, the glass beads, when packed in maximum packing configuration of face center cubic array or hexagonal closest packing, have a density less than the density of water. If a metallic coating, such as Chromium and/or Molybdenum, is employed for the beads, the coating can supplement the thermal conductivity of the beads such that the thermal conductivity is at least 10% of the water thermal conductivity.

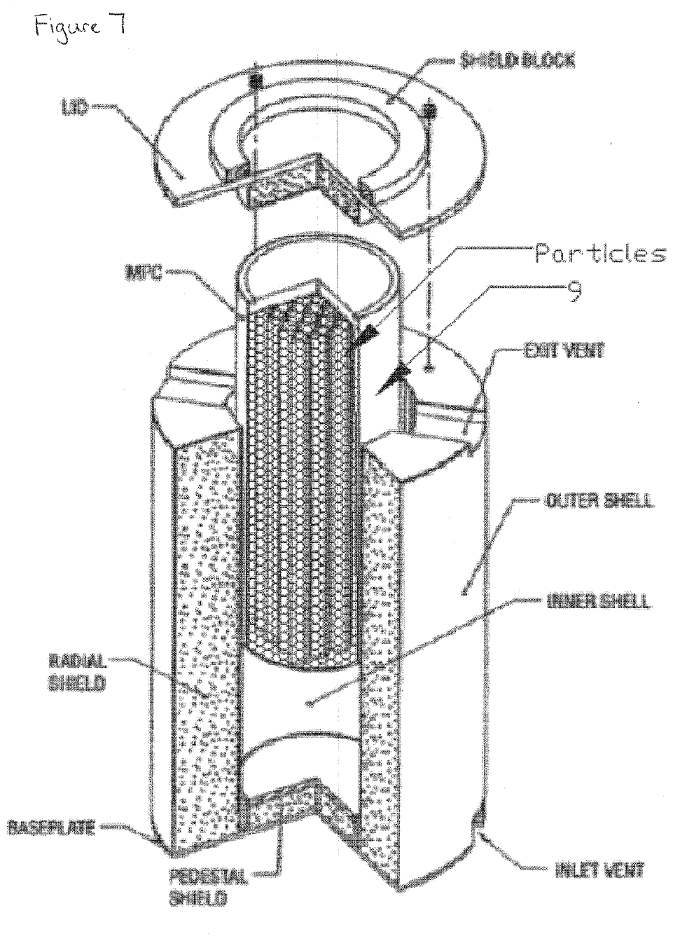

Illustratively as in FIG. 7, the additive herein disclosed can be used as a cask 9 additive to package nuclear material such as nuclear waste, nuclear fuel, and spent nuclear fuel in a nuclear fuel cask. The cask 9 can have a pedestal shield, a base plate, an inlet vent, a radial shield, an inner shell, an exit vent, an MPC, a lid, and a shield block. The additive can be “poured” into the cask after initial fuel loading while the cask is still in a fuel pool with an inner lid removed. Thereafter, the cask is then assembled to contain the additive and nuclear fuel or nuclear material, thereby producing a cask containing the additive.

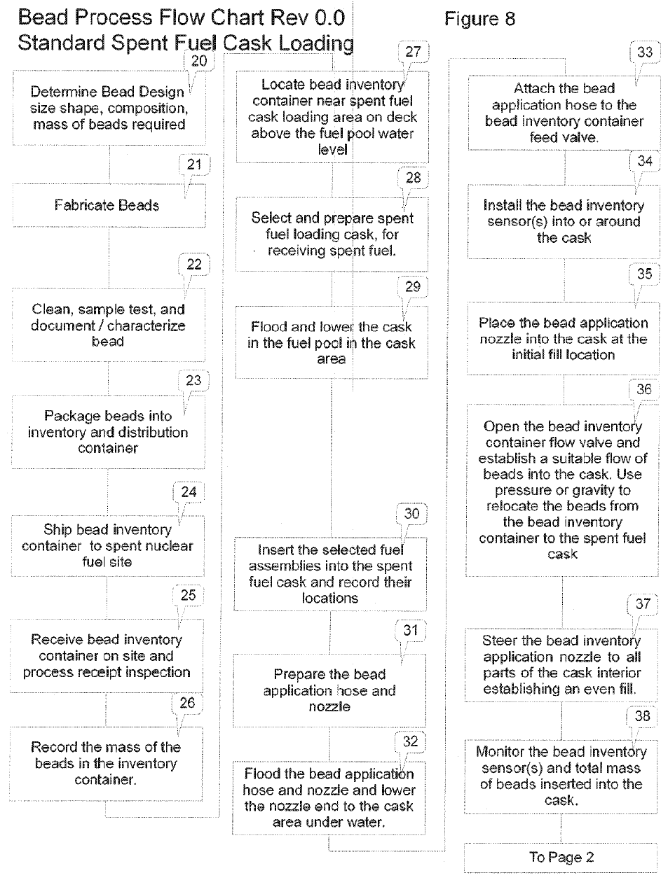

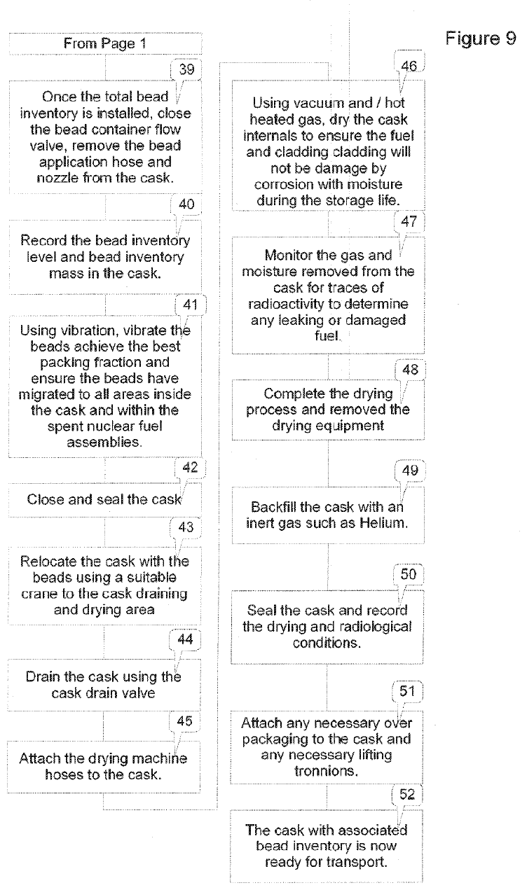

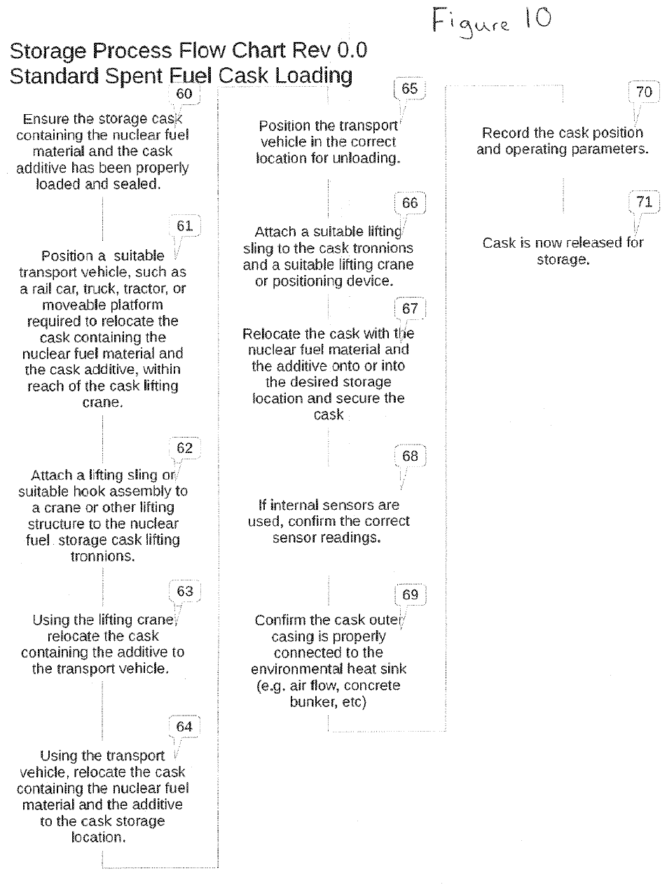

Turn now to FIG. 8 and FIG. 9 which is a continuation of FIG. 8, for an illustration of a flow chart indicating loading. Illustratively commencing at step 20,—Determine Bead Design size shape, composition, mass of beads required—At the beginning stages of the process, an engineer or team of engineers or technician or team of technicians determines the precise size, composition, and total mass of the particles to be used for a cask to be loaded, as per the embodiment of interest. The design, in part, focuses a particle configuration to optimize the installed particle group density and inventory. At step 21—Fabricate Beads—The beads, particles, or cask additive as specified in step 20 are fabricated by the situationally suitable process(es) described above. At step 22—Clean, sample test, and document/characterize bead (particle)—After fabrication, the particles are cleaned to ensure no trace or tramp elements are on the surface of the particles which could contaminate the internal cask environment. A fraction of the particles is selected for testing and characterization to ensure that they meet the manufacturing specification previously determined in step 20, and that the particles will perform as designed for both storage and transport. Documentation is made of the results of this testing and characterization for future reference. At step 23—Package beads (particles) into inventory and distribution container—The particles are packaged into suitable container for shipment to the cask loading site, i.e., not within a containment vessel of a nuclear reactor. The container can be standard industrial container typically used for material transport, a nuclear storage cask, spent nuclear storage cask, or the like. The container should offer suitable protection of the particles to prevent the particles from being damaged or contaminated while in transport. In the case of recycled particles, where some particles may be contaminated from previous use, the container may be a vessel suitable for radiological material shipment.

At step 24—Ship bead inventory container to spent nuclear fuel site—The container containing the particles is shipped to the cask loading site. This is typically a nuclear power station, but may be any location where spent nuclear fuel or nuclear fuel or nuclear waste material is being packaged for storage and/or transport. At step 25—Receive bead inventory container on site and process receipt inspection—When the container containing the particles arrives on site, a receipt inspection is performed to ensure the shipment and the container include the specified inventory of particles and that the shipment has not been tampered with, and that the particles have not been damaged, contaminated, or otherwise altered. At step 26—Record the mass of the particles in the inventory container.—The mass of the particles in the shipment is documented for future reference.

At step 27—Locate bead inventory container near spent fuel cask loading area on deck above the fuel pool water level—The container with the prescribed mass of beads or cask additive particles is relocated on site to a location operationally near the spent fuel cask loading area. This is typically on the deck above the spent fuel pool water level, thus allowing interconnection with the spent fuel loading equipment, specifically the equipment needed to install the beads. In another instance, the container may be flooded and placed into the nuclear fuel pool where the particle loading processes would place completely under water. At step 28—Select and prepare spent fuel loading cask, for receiving spent fuel—An appropriate spent fuel cask or nuclear fuel material storage cask is selected consistent with the design specifications for the manufacture of the particles, as described above. At step 29—Flood and lower the cask in the fuel pool in the cask area—The selected cask is flooded and lowered into the nuclear fuel pool and submerged to a suitable working level which allows placement of spent fuel assemblies into the cask while continuously providing shielding to the workers and cooling fuel assemblies. At step 30—Insert the selected fuel assemblies into the spent fuel cask and record their locations—The target spent fuel assemblies or target nuclear fuel material is loaded into the flooded cask as per the standard cask loading procedures.

At step 31—Prepare the bead application hose and nozzle—A suitable hose and distribution nozzle for the application of the beads or cask additive particles is prepared for use. The hose can be long enough to reach from the particle inventory container outlet valve to the cask internals allowing for placement of the particles into the cask. At step 32—Flood the bead application hose and nozzle and lower the nozzle end to the cask area under water.—The hose and distribution nozzle is placed in the pool and flooded with water with the nozzle placed near the cask at depth to disperse the particles into the cask. This ensures that the hose and nozzle assemble are filled with pool water for both maintaining nuclear radiation shielding and ease of maneuvering of the application hose and nozzle in the pool. At step 33—Attach the bead application hose to the bead inventory container feed valve—the inlet end of the flooded particle application hose is lifted from the water and attached to an outlet or feed valve or control device of the container containing the inventory of the particles. At step 34—Install the bead inventory sensor(s) into or around the cask—Sensor(s) (which may include cameras) are placed in or around the cask in order to measure and monitor the installation of the beads or cask additive particles and help to determine the density and optimal packing of the particles during loading. At step 35—Place the bead application nozzle into the cask at the initial fill location—The particle application nozzle is maneuvered into the opening of the cask such that as the beads will exit from the nozzle and they will fall into the cask internal volume either by gravity or by the flow of water which may be exiting the application nozzle. At step 36—Open the bead inventory container flow valve and establish a suitable flow of beads into the cask. Use pressure or gravity to relocate the beads from the bead inventory container to the spent fuel cask—The bead inventory container outlet or feed valve, connected to the distribution hose and application nozzle, is opened allowing a controlled flow of particle inventory to flow through the distribution hose and be guided by the application nozzle into the cask. This flow may be driven by gravity or assisted with pressure driven water flow wherein the beads are entrained in the water.

At step 37—Steer the bead inventory application nozzle to all parts of the cask interior establishing an even fill.—A worker, robot, or automated system can steer the application nozzle to affect an even distribution, density, and optimal packing of the particles into the cask internal volume. At step 38—Monitor the bead inventory sensor(s) and total mass of beads inserted into the cask.—During the loading process of the particles into the cask, the sensor(s) previously placed to monitor the loading process are checked to ensure the loading of the cask additive is occurring as predicted and that the correct inventory is being inserted and is located into the cask with the correct density and optimal packing arrangement. At step 39—Once the total bead inventory is installed, close the bead container flow valve, remove the bead application hose and nozzle from the cask.—Upon determination that the proper inventory of the particles has been loaded into the cask either by sensory information, visual indication by the operator, or indication by the automated equipment operating the distribution hose and nozzle, the outlet or feed valve on the bead inventories container is closed stopping the flow of particles into the cask. The distribution hose and nozzle are removed from the cask area and detached from the particle inventory container.

At step 40—Record the bead inventory level and bead inventory mass in the cask.—The inventory of the beads or cask additive particles loaded into the cask is recorded and compared to the specification determined above. At step 41—Using vibration, vibrate the beads achieve the best packing fraction and ensure the beads have migrated to all areas inside the cask and within the spent nuclear fuel assemblies.—The particle inventory in the cask is energized by using a vibrator(s), translation of the cask, or reorientation of the cask in order to overcome particle to particle friction and particle to structure friction and achieve the optimal packing fraction and optimal density of the beads or cask additive particles.

At step 42—Close and seal the cask—The cask containing the spent nuclear fuel or nuclear fuel material to be stored, and the inventory of beads or cask additive particles is closed and sealed by the normal procedures for the cask. At step 43—Relocate the cask with the beads using a suitable crane to the cask draining and drying area—The cask is relocated to the draining and drying area utilizing a suitable crane sufficient to lift the mass of the cask and its contents.

At step 44—Drain the cask using the cask drain valve—The cask is drained of pool water inventory acquired during the loading process.

At step 45—Attach the drying machine hoses to the cask.—Equipment designed to dry the cask internals and its inventory is attached to the connections on the cask body for this purpose. At step 46—Using vacuum and/hot heated gas, dry the cask internals to ensure the fuel and cladding will not be damage by corrosion with moisture during the storage life.—A drying machine applies heated gas and/or a vacuum to the cask internals and its inventory and particles in order to remove as much moisture and water vapor as possible. This is to ensure that the fuel assemblies and fuel material will not be damaged by corrosion during the time the cask is held for storage.

At step 47—Monitor the gas and moisture removed from the cask for traces of radioactivity to determine any leaking or damaged fuel.—An operator, robot, or automated equipment, monitors the drying equipment for progress in the drying process and monitors for any increase in radiological readings which may suggest a failure of one or more of the nuclear fuel structures contained in the cask. At step 48—Complete the drying process and removed the drying equipment—The drying process is completed. At the conclusion of the drying, the drying equipment is detached from the cask, and the cask drying valve is closed. At step 49—Backfill the cask with an inert gas such as Helium.—The cask is back filled with helium gas or other inert gas(es) to further prevent corrosion and create an inert environment. The gas is inserted into the cask using the drying valve or other cask port for this purpose.

At step 50—Seal the cask and record the drying and radiological conditions.—The cask is sealed and the particle inventory, moisture, gas content, and radiological conditions are recorded for future use. At step 51—Attach any necessary over packaging to the cask and any necessary lifting tronnions.—Depending upon the cask design, an over pack may be placed around the cask containing the nuclear material and particle inventory. Lifting tronnions may also be added at this time. At step 52—The cask with associated particle inventory applied in optimal density and packing fraction is now ready for transport.—The cask storage system, including the particles, is now ready to be transported or relocated to an appropriate storage location.

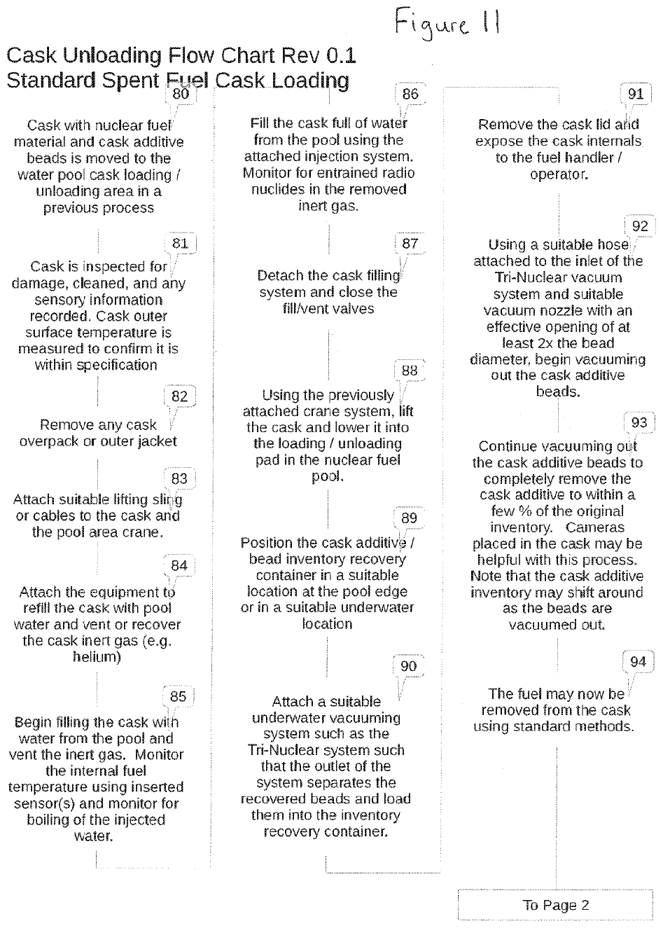

Consider now FIG. 10, which is an illustration of a flow chart indicating the storage process. At step 60—Ensure that the storage cask containing the nuclear fuel material and the cask additive has been properly loaded and sealed.—Ensure the storage cask containing the nuclear fuel material and the cask additive has been properly loaded and sealed. This may include review of documentation, physical inspection of the cask, and interrogation of sensor placed in and around the cask. At step 61—Position a suitable transport vehicle, such as a rail car, truck, tractor, or moveable platform required to relocate the cask containing the nuclear fuel material and the cask additive, within reach of the cask lifting crane.—Position a suitable transport vehicle, such as a rail car, truck, tractor, or moveable platform required to relocate the cask containing the nuclear fuel material and the cask additive, within reach of the cask lifting crane. At step 62—Attach a lifting sling or suitable hook assembly to a crane or other lifting structure to the nuclear fuel storage cask lifting tronnions.—Attach a lifting sling or suitable hook assembly to a crane or other lifting structure to the nuclear fuel storage cask lifting tronnions. At step 63—Using the lifting crane, relocate the cask containing the additive to the transport vehicle.—Using the lifting crane, relocate the cask containing the nuclear fuel material and the additive particles to the transport vehicle.

At step 64—Using the transport vehicle, relocate the cask containing the nuclear fuel material and the additive to the cask storage location.—Using the transport vehicle, relocate the cask containing the nuclear fuel material and the additive particles to the cask storage location. At step 65—Position the transport vehicle in the correct location for unloading.—Position the transport vehicle in the correct location for unloading of the cask containing the nuclear fuel material and the additive particles. At step 66—Attach a suitable lifting sling to the cask tronnions and a suitable lifting crane or positioning device.—Attach a suitable lifting sling to the cask tronnions and a suitable lifting crane or positioning device to the cask containing the nuclear fuel material and the additive particles. At step 67—Relocate the cask with the nuclear fuel material and the additive onto or into the desired storage location and secure the cask.—Relocate the cask with the nuclear fuel material and the additive particles onto or into the desired storage location and secure the cask. At step 68—If internal sensors are used, confirm the correct sensor readings.—If internal or other sensors are used, confirm the correct sensor readings as defined by the cask loading documentation and specifications. At step 69—Confirm the cask outer casing is properly connected to the environmental heat sink (e.g. air flow, concrete bunker, etc.)—Confirm the cask outer casing is properly connected to the environmental heat sink (e.g. air flow, concrete bunker, etc.). This ensures the cask can continue to dissipate heat over its storage life. At step 70—Record the cask position and operating parameters.—Record the cask position and operating parameters. Operating parameters may include temperature at various points on the cask surface and any internal sensor readings if sensors are used. At step 71—Cask is now released for storage.—The cask with the nuclear fuel material and the additive particles is now released for storage.

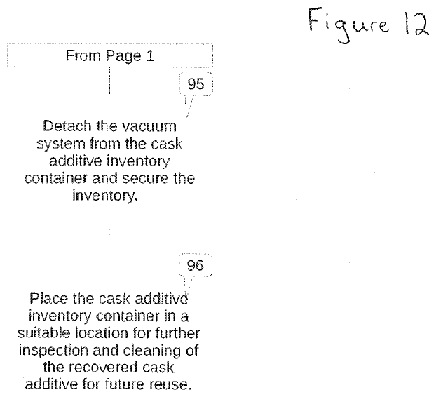

Next turn to FIG. 11, and FIG. 12 which is a continuation of FIG. 11, collectively providing an illustration of a flow chart indicating unloading. At step 80—Cask with nuclear fuel material and cask additive beads is moved to the water pool cask loading/unloading area in a previous process.—Cask with nuclear fuel material and cask additive beads is moved to the water pool cask loading/unloading area, e.g., as previously described. At step 81—Cask is inspected for damage, cleaned, and any sensory information recorded. Cask outer surface temperature is measured to confirm it is within specification.—Cask is inspected for damage, cleaned, and any sensory information recorded. Cask outer surface temperature is measured to confirm it is within specification. Instruments such as ultra-sound may be used to image the cask contents to determine nuclear fuel material condition, additive particle condition, nuclear fuel material position within the cask, and/or additive particle density or packing fraction. At step 82—Remove any cask overpack or outer jacket—Any over pack jacket is removed and relocated from the local area. This makes the cask for unloading.

At step 83—Attach suitable lifting sling or cables to the cask and the pool area crane.—Attach suitable lifting sling or cables to the cask and the pool area crane for lifting and relocating the cask containing the nuclear fuel material and additive particles. At step 84—Attach the equipment to refill the cask with pool water and vent or recover the cask inert gas (e.g., Helium).—Attach the required equipment to refill the cask with pool water and vent or recover the cask inert gas inventory (e.g., Helium). This may include inserting monitoring sensors such as temperature probes. At step 85—Begin filling the cask with water from the pool and vent the inert gas. Monitor the internal fuel temperature using inserted sensor(s) and monitor for boiling of the injected water.—Begin filling the cask with water from the pool and vent or collect the internal displaced gas. Monitor the internal fuel temperature using inserted sensor(s) and monitor for boiling of the injected water. Ensure the temperatures and boiling rate (if any) are within specifications. At step 86—Fill the cask full of water from the pool using the attached injection system. Monitor for entrained radio nuclides in the removed inert gas.—Continue to fill the cask until it is full of water from the pool using the attached injection system. Monitor for entrained radio nuclides in the removed displaced inert gas to determine the potential for fuel damage.

At step 87—Detach the cask filling system and close the fill/vent valves.—Detach the cask filling system and close the fill/vent valves. The cask should now be filled with water.

At step 88—Using the previously attached crane system, lift the cask and lower it into the loading/unloading pad in the nuclear fuel pool.—Using the previously attached crane system, lift the cask containing the nuclear fuel material and the additive particles and lower it into the loading/unloading pad in the nuclear fuel pool. At step 89—Position the cask additive/bead inventory recovery container in a suitable location at the pool edge or in a suitable underwater location.—Position the cask additive particle inventory recovery container in a suitable location at the pool edge or in a suitable underwater location.

At step 90—Attach a suitable underwater vacuuming system, such as the Tri-Nuclear system, such that the outlet of the system separates the recovered beads and load them into the inventory recovery container.—Attach a suitable underwater vacuuming system such as the Tri-Nuclear system and configure so that the outlet of the system separates the particles recovered by vacuuming and loads them into the inventory recovery container. Alternatively, a mechanical handling system may be installed which can be used to recover the particles.

At step 91—Remove the cask lid and expose the cask internals to the fuel handler/operator.—Remove the cask lid and expose the cask internals to the fuel handler or operator.

At step 92—Using a suitable hose attached to the inlet of the Tri-Nuclear vacuum system and suitable vacuum nozzle with an effective opening of at least 2× the bead diameter, begin vacuuming out the cask additive beads.—Using a suitable hose attached to the inlet of the (e.g.) Tri-Nuclear vacuum system and suitable vacuum nozzle with an effective opening of at least 2× the particle diameter, begin vacuuming out the particles. Alternatively, the mechanical handling system may be used to recover the particles. At step 93—Continue vacuuming out the cask additive beads to completely remove the cask additive to within a few percent of the original inventory. Cameras placed in the cask may be helpful with this process. Note that the cask additive inventory may shift around as the beads are vacuumed out.—Continue vacuuming out the cask additive beads to completely remove the cask additive to within a few percent of the original inventory. Cameras placed in the cask may be helpful with this process. Note that the cask additive inventory may shift around as the beads are vacuumed out. At step 94—The fuel may now be removed from the cask using standard methods.—The nuclear fuel, nuclear waste, and/or other nuclear material contained in the cask may now be removed from the cask using standard methods.

At step 95—Detach the vacuum system from the cask additive inventory container and secure the inventory.—Detach the vacuum system from the cask additive particle inventory container and secure the particle inventory. At step 96—Place the cask additive inventory container in a suitable location for further inspection and cleaning of the recovered cask additive for future reuse.—Place the cask additive particle inventory container in a suitable location for further inspection and cleaning of the recovered cask additive for future reuse. Inspection may include sensors, visual inspection, and sampling.

In any one of the embodiments herein, there is provided a process including the steps of: changing density of a composition including a neutron absorbent, the absorbent having a neutron absorption cross section greater than or equal to Boron comprising at least 19.7% of Boron-10 isotope, and a thermal conductor having a thermal conductivity of at least 10% of coolant thermal conductivity at 100 degrees C. at sea level, combined into the particles that have a density of at least 0.9982 g/mL and not more than 2.0 g/ml, the altering carried out in association with nuclear fuel or nuclear waste in a cask that is not located in a nuclear reactor containment vessel, the cask being a nuclear fuel cask or a spent nuclear fuel cask, the changing carried out by relocating the composition by at least one of the sub steps comprising:

(A) operating a hollow conduit connected to a reservoir to relocate at least some of the particles from a reservoir into the cask, and/or

(B) altering a close pack formation of the particles by effectuating a change from a static coefficient of friction of the particles to a dynamic coefficient of friction of the particles, thereby redistributing the particles within the cask into an altered close pack formation, and/or

(C) removing at least some of the particles from the cask into the reservoir.

In any one of the embodiments herein, the changing of the density of the composition is carried out with the composition comprising a composite that includes metal, glass, and inert gas.

In any one of the embodiments herein, the changing of the density of the composition is carried out with the particles being layered, with at least one bubble of helium, an outer layer of chromium and/or molybdenum, and borosilicate glass between said at least one bubble and the outer layer.

In any one of the embodiments herein, the changing of the density of the composition is carried out with the particles being layered, with at least one bubble of helium, an outer layer of chromium and/or molybdenum, and ceramic containing the neutron absorbent between said at least one bubble and the outer layer.

In any one of the embodiments herein, the changing of the density of the composition is carried out with the particles including an aggregate, with at least one bubble of helium, an outer layer of chromium and/or molybdenum, and borosilicate glass and/or a ceramic containing the neutron absorbent between said at least one bubble and the outer layer.

In any one of the embodiments herein, the changing of the density of the composition is carried out with the particles, when packed in maximum packing configuration of face center cubic array or hexagonal closest packing, having a gross density less than or equal to the density of water.

In any one of the embodiments herein, the process is carried out with the particles include particles that have a static coefficient of friction between 0.02 and 0.75.

In any one of the embodiments herein, the process is carried out with an additive that behaves as a non-Newtonian fluid.

In any one of the embodiments herein, the process is carried out with the particles having sufficient structural integrity, size, and friction that, when packed in random maximum density packing, collectively resist deflection and/or displacement of forces between 10 g's and 40 g's.

In any one of the embodiments herein, the process is carried out with at least some of the particles that deformably provide a cushion against the mechanical shocks.

In any one of the embodiments herein, the process is carried out with at least some of the particles that provide a deformable cushion against the mechanical shocks beyond 10 g's.

In any one of the embodiments herein, the process is carried out with the particles including particles that are spherical shaped, and/or spheroid shaped, and/or ellipsoid shaped and have a dimension in the range of 0.1 mm to 20 mm

In any one of the embodiments herein, the process is carried out with the neutron absorption cross section provided by Boron comprising at least 19.7% of Boron-10 isotope.

In any one of the embodiments herein, the process is carried out with the particles produced from at least one waste stream or recycled product.

In any one of the embodiments herein, the changing density of the composition is carried out with the particles including a bubble at least primarily filled with Helium.

In any one of the embodiments herein, the process is carried out with at least some of the particles have a wall thickness between said at least one bubble and an outer particle diameter in the range of 0.10 mm to 15 mm.

In any one of the embodiments herein, the changing of the density of the composition is carried out with the particles including more than one bubble at least one the bubble being filled or primarily filled with Helium.

In any one of the embodiments herein, the changing of the density of the composition is carried out with the particles including a foam of bubbles, at least some of the bubbles being filled or primarily filled with Helium.

In any one of the embodiments herein, the process is carried out with the particles comprising borosilicate glass.

In any one of the embodiments herein, the process is carried out with the thermal conductor comprising a metallic coating on the particles.

In any one of the embodiments herein, the process is carried out with the metallic coating comprising chromium and/or molybdenum.

In any one of the embodiments, the process can be carried out with the sub step of operating a hollow conduit connected to a reservoir to relocate at least some of the particles from a reservoir into the cask, that is to say, a loading process.

In any one of the embodiments herein, the process is carried out with the process including a loading process, including the sub step of operating a hollow conduit connected to a reservoir to relocate at least some of the particles from the reservoir into the cask.

In any one of the embodiments involving the loading process, the loading process is carried out with the sub step of altering a close pack formation.

In any one of the embodiments involving the loading process, the loading process is carried out with the altering carried out by applying at least one of mechanical, sonic, and hydraulic energy to the particles, to the cask, or to both.

In any one of the embodiments involving the loading process, the loading process is carried out with the particles being relocated from the reservoir or through the conduit at least in part by applying energy or pressure to the particles.

In any one of the embodiments involving the loading process, the loading process is carried out with the particles being relocated from the reservoir or through the conduit primarily by gravity.

In any one of the embodiments involving the loading process, the loading process is carried out with the particles being relocated by distributing the particles into spaces around the nuclear fuel or nuclear waste, in some but not all, cases such that less than 1% of the particles do not sustain damage or alteration of their shape from prior to the distributing.

In any one of the embodiments involving the loading process, the loading process is carried out with including locating at least one sensor within the cask, the sensor adapted to detect a condition within the cask.

In any one of the embodiments involving the loading process, the loading process is carried out with the condition is one of temperature, pressure, and radioactivity.

In any one of the embodiments involving the loading process, the loading process is carried out with after the cask is closed to seal therein the nuclear fuel or nuclear waste and the particles, and the sensor indicative of a warning to open the cask to remediate the condition.

In any one of the embodiments involving the loading process, the loading process is carried out by cleaning the particles prior to the sub step of operating the hollow conduit connected to the reservoir to relocate the particles from the reservoir into the cask.

In any one of the embodiments involving the loading process, the loading process is carried out with, after the cask is closed to seal therein the nuclear fuel or nuclear waste and the particles, removing coolant from the cask, and thereafter backfilling the cask with an inert gas.

In any one of the embodiments involving the loading process, the loading process is carried out with the backfilling carried out with Helium as the inert gas.

In any one of the embodiments herein, the process also includes the sub step of altering the close pack formation of the particles.

In any one of the embodiments herein, the process also includes the sub step of altering the close pack formation of the particles.

In any one of the embodiments, the process includes the altering of a close pack formation of the particles by effectuating a change from a static coefficient of friction of the particles to a dynamic coefficient of friction of the particles, thereby redistributing the particles within the cask into an altered close pack formation.

In any one of the embodiments in which the process includes the altering is carried out by applying at least one of mechanical, sonic, and hydraulic energy to the particles, to the cask, or to both.

In any one of the embodiments in which the process includes the altering sub step, the altering is carried out after the cask is closed to seal therein the nuclear fuel or nuclear waste and the particles.

In any one of the embodiments in which the process includes the altering sub step, the altering is carried out after the cask is closed to seal therein the nuclear fuel or nuclear waste and the particles.

In any one of the embodiments in which the process includes the altering sub step, the altering is carried out by vibrating the cask while relocating the cask and/or changing position of the cask.

In any one of the embodiments in which the process includes the altering sub step, the relocating the cask and/or changing position of the cask is carried out by relocating the cask from a nuclear pool.

In any one of the embodiments in which the process includes the altering sub step, the relocating the cask and/or changing position of the cask is carried out by relocating the cask to a nuclear fuel storage or staging installation.

In any one of the embodiments in which the process includes the altering sub step, the altering is carried out by vibrating the cask during transporting the cask by road, rail, air, seaborn vessel or any combination of them.

In any one of the embodiments in which the process includes the altering sub step, the altering is carried out by during cask dry storage of the nuclear fuel or waste supported by the particles.

In any one of the embodiments, the process includes the sub step of removing at least some of the particles from the cask into the reservoir.

In any one of the embodiments in which the process includes the sub step of removing, the process is carried out with the process including the sub step of removing at least some of the particles from the cask into the reservoir.

In any one of the embodiments in which the process includes the sub step of removing, the operating of the hollow conduit to relocate the particles from the cask into the reservoir is carried out after flooding the cask with a coolant and after opening the cask, and prior to removing the nuclear fuel or nuclear waste.

In any one of the embodiments in which the process includes the operating, the operating of the hollow conduit to relocate the particles from the cask into the reservoir is carried out by removing at least some of the particles from the cask via a vacuum hose or channel, or mechanically.

In any one of the embodiments in which the process includes the operating, the operating the hollow conduit to relocate the particles from the cask into the reservoir is carried out such that less than 1% of the particles do not sustain damage or alteration of their shape from prior to the distributing

In any one of the embodiments in which the process includes the sub step of removing, the process can further include filtering to separate the particles from the coolant; and then cleaning or refurbishing the particles; and then recycling some of the particles into another cask to enable storage of other nuclear fuel or waste.

Indeed, the process can be carried out with any one of the sub steps, any two of the sub steps, or any three of the sub steps.

Any one of the embodiments can be carried out as a process of using a nuclear fuel cask additive, the process including relocating at least some of a nuclear fuel cask additive, adjacent a coolant and intermediate a nuclear fuel or nuclear waste and a nuclear fuel cask, the additive comprising a non-gaseous neutron absorbent having a neutron absorption cross section greater than Boron comprising 21% of Boron-10 in a combination with and a thermal conductor such that the combination has a thermal conductivity of at least 10% of water thermal conductivity, the combination providing a cushion against mechanical shocks while being mechanically, chemically, and atomically stable at 100 degrees C. for more than 100 years.

Any one of the embodiments involving the using of the nuclear fuel cask additive can be carried out such that the relocating is carried out by adding more of the nuclear fuel cask additive intermediate the nuclear fuel or nuclear waste and the nuclear fuel cask.

Any one of the embodiments involving the using of the nuclear fuel cask additive can be carried out such that the nuclear fuel cask additive comprises the glass beads; the nuclear fuel or waste is the nuclear fuel; and at a time prior to adding the glass beads, there is a cleaning the glass of the beads.

Any one of the embodiments involving the using of the nuclear fuel cask additive can be carried out such that the adding of the nuclear fuel cask additive includes: conveying the glass beads via a hose or channel into the nuclear fuel cask to facilitate distribution of the glass beads into spaces around the nuclear fuel, and regulating the conveying such that the glass beads do not sustain damage or alteration of their shape beyond 0.05% of the glass beads that have been acquired.

Any one of the embodiments involving the using of the nuclear fuel cask additive can be carried out such that energy or pressure is added to the beads to relocate the beads into a closer packing formation within the nuclear fuel cask.

Any one of the embodiments involving the using of the nuclear fuel cask additive can be carried out such that a level or amount of the nuclear fuel cask additive added into the nuclear fuel cask is monitored by at least one sensor.

Any one of the embodiments involving the using of the nuclear fuel cask additive can be carried out such that the relocating is carried out by relocating, from a nuclear pool, the nuclear fuel cask containing the nuclear fuel cask additive and the nuclear fuel or nuclear waste.

Any one of the embodiments involving the using of the nuclear fuel cask additive can be carried out as including storing the nuclear fuel cask containing the nuclear fuel cask additive and the nuclear fuel or waste at a nuclear fuel storage or staging installation.

Any one of the embodiments involving the using of the nuclear fuel cask additive can be carried out such that the storing comprises dry cask storing.

Any one of the embodiments involving the using of the nuclear fuel cask additive can be carried out as further including: at a time after the storing, opening the nuclear fuel cask, and then flooding the nuclear fuel cask and the nuclear fuel or nuclear waste with coolant; and then withdrawing at least some of the nuclear fuel cask additive; and then removing nuclear fuel or waste.

Any one of the embodiments involving the using of the nuclear fuel cask additive can be carried out as further including: transporting the nuclear fuel cask containing the nuclear fuel cask additive and the nuclear fuel or nuclear waste via road, rail, air, seaborn vessel or any combination of them, and then storing the nuclear fuel cask containing the nuclear fuel cask additive and the nuclear fuel at a nuclear fuel storage or staging installation.

Any one of the embodiments involving the using of the nuclear fuel cask additive can be carried out such that the relocating is carried out by removing at least some of the nuclear fuel cask additive from the nuclear fuel cask.

Any one of the embodiments involving the using of the nuclear fuel cask additive can be carried out such that the coolant comprises water and the relocating further includes: at a time after the nuclear fuel cask has been sealed to contain the nuclear fuel cask additive and the nuclear fuel or nuclear waste, venting the nuclear fuel cask; and removing the water from the nuclear fuel cask sufficient to produce dry storage of the nuclear fuel or nuclear waste supported by the additive.

Any one of the embodiments involving the using of the nuclear fuel cask additive can be carried out as including, after the removing of the water, backfilling the nuclear fuel cask with Helium.

Any one of the embodiments involving the using of the nuclear fuel cask additive can be carried out with the coolant comprising water, further including: at a time after the dry storage but prior to said removing of the at least some of the nuclear fuel cask additive, opening the nuclear fuel cask, and flooding the nuclear fuel cask and the nuclear fuel or nuclear waste with the water; and then carrying out said removing of the at least some of the nuclear fuel cask additive, along with the water.

Any one of the embodiments involving the using of the nuclear fuel cask additive can be carried out such that the removing said at least some of the nuclear fuel cask additive includes: facilitating removal of the glass beads from spaces around the nuclear fuel or waste by acquiring the glass beads, via a vacuum hose or channel, or mechanically, from the nuclear fuel cask, thereby, and regulating the facilitated removal such that the glass beads do not sustain damage or alteration of their shape beyond 0.05% of the beads that have been acquired.

Any one of the embodiments involving the using of the nuclear fuel cask additive can be carried as further including: filtering to separate the nuclear fuel cask additive from the water; and then purifying the glass beads; and then recycling some of the glass beads into another relocating of at least some of a nuclear fuel cask additive, adjacent a coolant and intermediate a nuclear fuel or nuclear waste and a nuclear fuel cask.

Any one of the embodiments involving the using of the nuclear fuel cask additive can be carried out as including removing the nuclear fuel or waste from the nuclear fuel cask or resealing the cask to contain the nuclear fuel or waste.

It is important to recognize that this disclosure has been written as a thorough teaching rather than as a narrow dictate or disclaimer. Reference throughout this specification to “one embodiment”, “an embodiment”, or “a specific embodiment” means that a particular feature, structure, or characteristic described in connection with the embodiment is included in at least one embodiment and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other embodiments. It is to be understood that other variations and modifications of the embodiments described and illustrated herein are possible in light of the teachings herein and are to be considered as part of the spirit and scope of the present subject matter.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments, including what is described in the Abstract and the Disclosure and the Industrial Applicability, are not intended to be exhaustive or to limit the subject matter to the precise forms disclosed herein. While specific embodiments of, and examples for, the subject matter are described herein for teaching-by-illustration purposes only, various equivalent modifications are possible within the spirit and scope of the present subject matter, as those skilled in the relevant art will recognize and appreciate. As indicated, these modifications may be made in light of the foregoing description of illustrated embodiments and are to be included, again, within the true spirit and scope of the subject matter disclosed herein.

1. A process including the steps of:
changing density of a composition including a neutron absorbent, the absorbent having a neutron absorption cross section greater than or equal to Boron comprising at least 19.7% of Boron-10 isotope, and a thermal conductor having a thermal conductivity of at least 10% of coolant thermal conductivity at 100 degrees C. at sea level, combined into the particles that have a density of at least 0.9982 g/mL and not more than 2.0 g/ml, the altering carried out in association with nuclear fuel or nuclear waste in a cask that is not located in a nuclear reactor containment vessel, the cask being a nuclear fuel cask or a spent nuclear fuel cask, the changing carried out by relocating the composition by at least one of the sub steps comprising:
(A) operating a hollow conduit connected to a reservoir to relocate at least some of the particles from a reservoir into the cask, and/or
(B) altering a close pack formation of the particles by effectuating a change from a static coefficient of friction of the particles to a dynamic coefficient of friction of the particles, thereby redistributing the particles within the cask into an altered close pack formation, and/or
(C) removing at least some of the particles from the cask into the reservoir.

2. The process of claim 1, wherein changing density of the composition is carried out with the composition comprising a composite that includes metal, glass, and inert gas.

3. The process of claim 2, wherein changing density of the composition is carried out with the particles being layered, with at least one bubble of helium, an outer layer of chromium and/or molybdenum, and borosilicate glass between said at least one bubble and the outer layer.

4. The process of claim 2, wherein changing density of the composition is carried out with the particles being layered, with at least one bubble of helium, an outer layer of chromium and/or molybdenum, and ceramic containing the neutron absorbent between said at least one bubble and the outer layer.

5. (canceled)

6. (canceled)

7. The process of claim 1, wherein the particles include particles that have a static coefficient of friction between 0.02 and 0.75.

8. The process of claim 7, wherein the additive behaves as a non-Newtonian fluid.

9. The process of claim 8, wherein the particles have sufficient structural integrity, size, and friction that, when packed in random maximum density packing, collectively resist deflection and/or displacement of forces between 10 g's and 40 g's.

10. The process of claim 9, wherein at least some of the particles deformably provide a cushion against the mechanical shocks.

11. (canceled)

12. The process of claim 1, where the particles include particles that are spherical shaped, and/or spheroid shaped, and/or ellipsoid shaped and have a dimension in the range of 0.1 mm to 20 mm.

13. (canceled)

14. (canceled)

15. (canceled)

16. (canceled)

17. (canceled)

18. (canceled)

19. (canceled)

20. (canceled)

21. (canceled)

22. The process of claim 1, wherein the process includes the sub step of operating a hollow conduit connected to a reservoir to relocate at least some of the particles from the reservoir into the cask.

23. The process of claim 22, further including the sub step of altering a close pack formation.

24. The process of claim 23, wherein the altering is carried out by applying at least one of mechanical, sonic, and hydraulic energy to the particles, to the cask, or to both.

25. (canceled)

26. (canceled)

27. (canceled)

28. The process of claim 22, further including locating at least one sensor within the cask, the sensor adapted to detect a condition within the cask.

29. (canceled)

30. (canceled)

31. The process of claim 1, further including, after the cask is closed to seal therein the nuclear fuel or nuclear waste and the particles, removing coolant from the cask, and thereafter backfilling the cask with an inert gas.

32. (canceled)

33. (canceled)

34. (canceled)

35. (canceled)

36. (canceled)

37. (canceled)

38. (canceled)

39. (canceled)

40. (canceled)

41. (canceled)

42. The process of claim 1, wherein the process includes the sub step of removing at least some of the particles from the cask into the reservoir and operating hollow conduit to relocate the particles from the cask into the reservoir after flooding the cask with a coolant and after opening the cask, and prior to removing the nuclear fuel or nuclear waste.

43. (canceled)

44. The process of claim 42, wherein the operating the hollow conduit to relocate the particles from the cask into the reservoir is carried out by removing at least some of the particles from the cask via a vacuum hose or channel, or mechanically.

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. The process of claim 1, further including:
at a time after dry cask storing the nuclear fuel cask additive and the nuclear fuel or waste, opening the nuclear fuel cask, and then
flooding the nuclear fuel cask and the nuclear fuel or nuclear waste with coolant; and
then carrying out the removing; and then
removing the nuclear fuel or waste.

59. The process of claim 1, further including:
transporting the nuclear fuel cask containing the nuclear fuel cask additive and the nuclear fuel or nuclear waste via road, rail, air, seaborn vessel or any combination of them, and then
storing the nuclear fuel cask containing the nuclear fuel cask additive and the nuclear fuel at a nuclear fuel storage or staging installation.

60. (canceled)

61. (canceled)

62. (canceled)

63. (canceled)

64. (canceled)

65. (canceled)

66. (canceled)

67. A process of using a composition, the process including:
locating a composition to release, responsive to a loss of normal heat sink event and/or a loss of normal coolant event, the composition consisting essentially of a neutron absorbent, the absorbent having a neutron absorption cross section greater than or equal to Boron comprising at least 19.7% of Boron-10 isotope, and a thermal conductor having a thermal conductivity of at least 10% of water thermal conductivity at 100 degrees C. at sea level, combined such that the particles have a density of at least 0.9982 g/mL and not more than 2.0 g/ml, the composition at a location, and in a quantity sufficient, to palliate the loss of the normal heat sink event and/or the loss of normal coolant event.

68. A nuclear fuel environment additive, the additive including:
particles made of a composite material including a neutron absorbent, the absorbent having a neutron absorption cross section greater than or equal to Boron comprising at least 19.7% of Boron-10 isotope, and a thermal conductor having a thermal conductivity of at least 10% of water thermal conductivity at 100 degrees C. at sea level, combined such that the particles have a density of at least 0.9982 g/mL and not more than 2.0 g/ml.
